(19) United States
(12) Patent Application Publication
(10) Pub. No.: US 2005/0067817 A1
(43) Pub. Date: Mar. 31, 2005

(54) Security module component for a motor vehicle security device

(75) Inventors: Ola Bostrom, Alingsas (SE); Yngve Haland, Falsterbo (SE)

Correspondence Address: ROBERT W. BECKER & ASSOCIATES, Suite B, 707 Highway 66 East, Tijeras, NM, 87059, US

(73) Assignee: Autoliv Development AB, Vargrda (SE)

(21) Appl. No.: 10/727,412

(22) Filed: Dec. 4, 2003

(30) Foreign Application Priority Data
Sep. 25, 2003 (DE) 203 14 923.8

(51) Int. Cl. B60R 21/22; B60R 22/26

(52) U.S. Cl. 280/730.2; 297/483

(57) ABSTRACT

A security module for a motor vehicle security device includes a module housing, a belt take-up roller for the taking up onto, and the unwinding therefrom, of a safety belt operable to belt in a seat occupant seated in a vehicle seat in the motor vehicle, and a side airbag module having an airbag inflatable into a deployed position in which it provides lateral support for the seat occupant. The side airbag module also includes an associated gas generator for supplying compressed gas to effect deployment of the airbag. The take-up roller, the safety belt, and the side airbag module are commonly mounted in the module housing, which can be mounted relative to the seat back of the vehicle seat either during installation of the vehicle seat itself during the vehicle production or as an aftermarket installation.

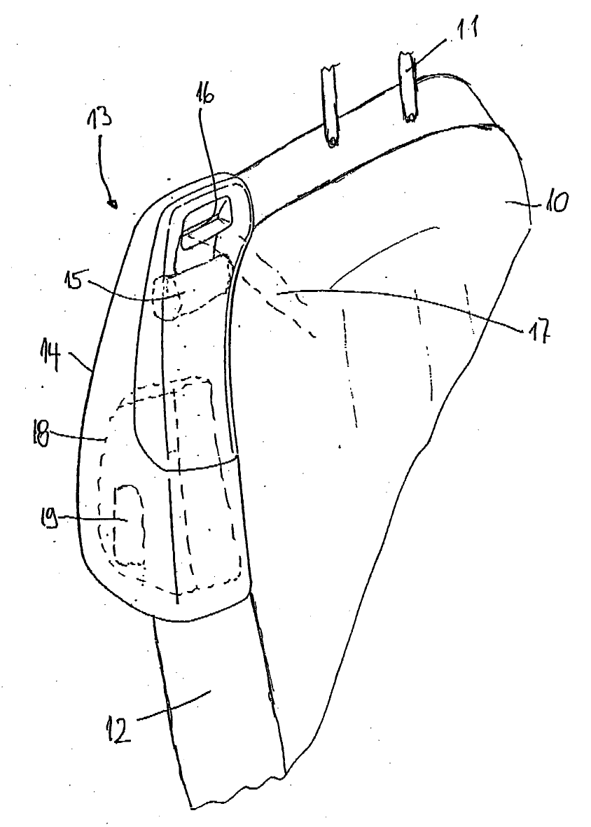

### BACKGROUND OF THE INVENTION

The present invention relates to a security module comprised as a component of a security device for a motor vehicle.

Security devices of the above-noted type are initially comprised of a vehicle seat safety belt, the safety belt being configured as a two-point or three-point belt taken up onto, and unwindable from, an associated belt take-up roller, whereby the belt take-up roller is either secured to the body of the vehicle or is directly integrated into the vehicle seat. A safety belt take-up roller directly integrated into the vehicle seat is described, for example, in U.S. Pat. No. 5,123,673, whereby the safety belt arrangement described therein comprises, in addition to a three-point safety belt, a two-point safety belt; both safety belt take-up rollers associated with the pair of safety belts are integrated into the seat back of the vehicle seat and, in fact, are located at approximately the shoulder region of a seat occupant seated in the vehicle seat.

Moreover, there are also, among the types of security devices in a motor vehicle, airbag devices comprising airbags and gas generators associated with the airbags for supplying compressed gas to effect deployment of the airbags, whereby such airbag devices, in addition to being disposed at various locations on the vehicle body, find particular use as so-called side airbags which are integrated into the seat back of a vehicle seat and are covered by the covering component of the vehicle seat and, upon the supply thereto of compressed gas from the gas generator, unfold through a separation of the seat covering into a lateral position relative to the seat occupant, whereupon the deployed side airbag provides a lateral support of the upper torso of the seat occupant.

The above-noted state of the art security devices suffer, however, from the disadvantage that the installation thereof into motor vehicles or, respectively, into vehicle seats, requires provisions and accommodations of the vehicle body or, respectively, the vehicle seat and, as well, several such conventional security devices require steps during the seat production or, respectively, the mounting of the body, in order to mount these security devices at their respective mounted locations.

### SUMMARY OF THE INVENTION

The present invention offers a solution to the challenge of providing a security module that can be installed in a motor vehicle independent of the respective installations of vehicle components or the vehicle seats in the motor vehicle.

The present invention provides, in accordance with its core concepts, a security module by which a belt take-up roller for a safety belt operable for a vehicle seat and a side airbag module with an inflatable airbag for providing lateral support of a seat occupant seated on a vehicle seat are commonly mounted in a module housing as is, as well, a gas generator associated with the airbag. In accordance with the present invention, initially, a safety belt take-up roller and a side airbag module are mounted in a common module housing, whereby such a module housing can be installed in an individual manner in a motor vehicle or, as the occasion arises, can be installed in an after-market manner in a motor vehicle or, respectively, on a vehicle seat. No particular accommodations of the vehicle body or, respectively, the vehicle seat, are required with the exception that corresponding securement recesses must be provided for securement of the inventive security module.

In accordance with one embodiment of the present invention, it is provided that, initially, the security module is configured for mounting on a side wall of the seat back of a vehicle seat, whereby it can be provided that the respective wall of the module housing that lies against the seat back of the vehicle seat is compatibly configured with the outer contour of the side wall of the seat back. In this manner, there is provided an optically aesthetic integration of the module housing with the vehicle seat or, respectively, its seat back, with the security module following the contour path of the vehicle seat.

With respect to the embodiments of the present invention, the security module can alternatively either be disposed on the inboard side of the seat back of the vehicle seat facing toward the interior of the vehicle or, alternatively, on the outboard side of the seat back of the vehicle seat facing toward the body frame of the vehicle.

It can also be provided that the module housing is configured for securement to a vehicle column.

With respect to the configuration of the security module, it can further be provided that the belt take-up roller is disposed adjacent an exit slot formed in the module housing through which the safety belt exits the module housing and that the side airbag module is located underneath the belt take-up roller. In this connection, it can be provided that the module housing is so mounted and oriented on the seat back of the vehicle seat that the exit slot for the safety belt is disposed in the region of the upper edge of the seat back and the airbag of the side airbag module exits the airbag module in the region of the upper arm of a seat occupant seated on the vehicle seat.

It serves a useful purpose if the module housing is provided with a predetermined give-way location operable to give way so as to provide an exit opening through which the airbag deploys from the module housing.

Moreover, in connection with one embodiment of the present invention, the belt take-up roller and side airbag module are connected to a common control and the module housing comprises a socket plug for common connection of the belt take-up roller and side airbag module to the vehicle control system.

### BRIEF DESCRIPTION OF THE DRAWING

One embodiment of the security module of the present invention is illustrated hereinafter with reference to the sole FIGURE of the drawing.

The sole FIGURE of the drawing is a perspective view of a portion of a seat back of a vehicle seat having the inventive security module mounted thereon.

### DETAILED DESCRIPTION OF THE PREFERRED EMBODIMENT

As can be seen in the sole FIGURE of the drawing, a seat back 10 of a vehicle seat is provided with a security module 13 secured thereto, the seat back 10 having a headrest 11 and a side wall 12, whereby the security module 13 is secured to the side wall 12 of the seat back 10 in a not-illustrated manner.

A belt take-up roller 15 for the taking up onto, and the unwinding therefrom, of a safety belt 17 is disposed within a module housing 14 of the security module 13, the safety belt 17 exiting the module housing 14 via an exit slot 16. Additionally, a side airbag module 18 is disposed within the module housing 14, whereby, in the side airbag module 18, a gas generator 19 and a folded airbag, further details of which are not illustrated, are disposed. The surface of the module housing 14 facing the side wall 12 is compatibly configured with respect to the contour of the seat back 10 or, respectively, the side wall of the seat back, and the module housing extends in a shape following manner over the upper corner region of the seat back 10. The exit slot 16 for the passage of the safety belt 17 therethrough is disposed at this upper corner region of the seat back 10 such that the exit slot 16 is thereby located in the region of the upper edge of the seat back.

The specification incorporates by reference the disclosure of German priority document 203 14 923.8 filed 25 Sep. 2003.

The present invention is, of course, in no way restricted to the specific disclosure of the specification and drawing, but also encompasses any modifications within the scope of the appended claims.

1. A security module for a motor vehicle security device, comprising:
a module housing;
a belt take-up roller for the taking up onto, and the unwinding therefrom, of a safety belt operable to belt in a seat occupant seated in a vehicle seat in the motor vehicle; and
a side airbag module having an airbag inflatable into a deployed position in which it provides lateral support for the seat occupant, the side airbag module also including an associated gas generator for supplying compressed gas to effect deployment of the airbag, the take-up roller, the safety belt, and the side airbag module being commonly mounted in the module housing.

2. A security module according to claim 1, wherein the security module is adapted to be mounted on a side wall of the seat back of the vehicle seat.

3. A security module according to claim 2, wherein the module housing includes a wall disposed against the side wall of the seat back having a shape conforming to the outer contour of the side wall of the seat back.

4. A security module according to claim 2, wherein the module housing comprises an outer surface compatibly configured with a seat cover that covers the vehicle seat.

5. A security module according to claim 2, wherein the security module is disposed on the inboard, vehicle interior-facing, side of the seat back of the vehicle seat.

6. A security module according to claim 2, wherein the security module is disposed on the outboard side of the seat back of the vehicle seat facing toward the body frame of the vehicle.

7. A security module according to claim 1, wherein the security module is configured for mounting on a column of a motor vehicle.

8. A security module according to claim 1, wherein the belt take-up roller is disposed adjacent an exit slot formed in the module housing through which the safety belt exits the module housing and the side airbag module is located underneath the belt take-up roller.

9. A security module according to claim 8, wherein the module housing is disposed on, and oriented relative to, the seat back of the vehicle seat such that the exit slot for the safety belt is disposed in the region of an upper edge of the seat back and the airbag of the side airbag module exits the module housing via the exit slot in the region of an upper arm of a seat occupant seated on the vehicle seat.

10. A security module according to claim 1, wherein the module housing comprises a predetermined give-way location operable to give way so as to provide an exit opening through which the airbag deploys from the module housing.

11. A security module according to claim 1, wherein the belt take-up roller and the side airbag module are connected to a common control and the module housing comprises a socket plug for common connection of the belt take-up roller and the side airbag module to a vehicle control system.
